(19) United States
(12) Patent Application Publication
(10) Pub. No.: US 2006/0170283 A1
(43) Pub. Date: Aug. 3, 2006

(54) Process and device for front/rear braking distribution for a decelerating vehicle

(76) Inventors: Belen Alvarez, Paris (FR); Xavier Marie Groult, Survilliers (FR); Philippe Blaise, Dampiere les Bois (FR)

Correspondence Address: DELPHI TECHNOLOGIES, INC., M/C 480-410-202, PO BOX 5052, TROY, MI, 48007, US

(21) Appl. No.: 11/188,924

(22) Filed: Jul. 25, 2005

(30) Foreign Application Priority Data
Jul. 26, 2004 (EP) 04291894.6

(51) Int. Cl. B60T 8/60

(52) U.S. Cl. 303/155

(57) ABSTRACT

A process for braking a vehicle provided with brake calipers which can be activated as a function of a target braking force, at least the activation of the brake calipers of the rear wheels being decoupled from depression of a brake pedal, including: detecting a logical entry condition including at least a deceleration test verified when an instantaneous value of the deceleration of the vehicle is greater than a threshold deceleration; calculating of a rear base braking force by correcting the braking force required by the driver so that the rear base braking force is greater than the front base braking force; and applying the rear base braking force as target braking force for the rear wheels, so that the pitching motion of the vehicle is reduced on deceleration.

### TECHNICAL FIELD

The field of the invention is the management of braking of a vehicle fitted with a decoupled braking system in the sense that activation of the brake calipers for application of a braking force to the wheels is decoupled from depression of the brake pedal by the driver. More particularly, the field of the invention is the management of braking to reduce the pitching motion of the vehicle body during a phase of deceleration of the vehicle.

### BACKGROUND OF THE INVENTION

During braking in a straight line, the braking force on the wheel is transmitted to the road. The reaction of the road on the vehicle generates a moment about a lateral axis passing through the centre of gravity of the vehicle. This moment applied to the suspended masses, i.e. the body, causes a load transfer from the rear to the front leading to a pitching motion. Consequently, the longitudinal axis of the vehicle forms an angle with the horizontal. This angle of pitch is perceived by the passengers and is detrimental to their comfort.

There is therefore a need for a braking system implementing a process permitting correction, at least partially, of the above-mentioned disadvantages.

### SUMMARY OF THE INVENTION

The object of the invention is a process for braking a vehicle, the vehicle being fitted with a braking system including brake calipers which can be activated as a function of a target braking force and in which at least the activation of the calipers fitted to the rear wheels is decoupled from depression of a brake pedal, which depression corresponds to a braking force required by the driver, the process including:

detecting a logical entry condition including at least a straight line test and a braking test, the straight line test being verified when the instantaneous lateral acceleration of the vehicle is less than a threshold acceleration and the braking test being verified when the brake pedal is operated by the driver; and while the logical condition is verified,

determining a base braking force from the required braking force;

calculating a corrected base braking force, by correcting the base braking force so that the corrected base braking force is greater than the base braking force; and

applying the corrected base braking force as target braking force for the rear wheels, so that the pitching motion of the vehicle is reduced on braking in a straight line.

Preferably, the base braking force is corrected by applying to it a multiplying base gain so as to obtain a corrected base braking force. Again, preferably, the base gain is an increasing function of an instantaneous velocity of the vehicle. Preferably, the instantaneous velocity on which the base gain depends is the instantaneous velocity on a modification of the braking force required by the driver. Preferably, the base gain is close to unity below a lower threshold velocity. Again, preferably, the base gain is equal to a saturation gain above an upper threshold velocity. In the preferred embodiment, the process includes modulating the corrected base braking force, the modulation being a function of the instantaneous value of a variable reflecting the slip of the rear wheels.

The invention also has as its object braking software containing instructions suitable to be read from and stored on a support, the instructions being executable by a host computer, wherein the software implements the process described above.

The invention also has as its object a programmable braking controller, able to implement the process described above, in a vehicle fitted with a braking system including brake calipers able to be activated as a function of a target braking force and in which at least the activation of the calipers fitted to the rear wheels is decoupled from depression of a brake pedal, which depression corresponds to a braking force required by the driver, the controller including a memory space able to store software instructions, a computer able to execute the instructions and an input/output interface connectable at its input to a plurality of sensors with which the vehicle is provided and at its output to at least one unit for caliper activation, wherein the controller is programmed to include:

a means for detecting a logical entry condition able to test a straight line condition by verifying whether a lateral acceleration obtained by means of the sensors is less than a threshold lateral acceleration, and a braking condition by verifying whether the brake pedal is depressed;

a means for determining a base braking force from the required braking force;

a means for calculating a corrected base braking force able to correct the base braking force so that the corrected base braking force is greater than the base braking force; and

a means for transmitting the corrected braking force as target braking force for the rear wheels, so that the pitching motion of the vehicle is reduced on deceleration.

Preferably, the controller includes modulation means able to apply a modulation to the corrected base braking force to obtain a reference braking force, the modulation being a function of a variable reflecting the slip of the rear wheels, and the reference braking force being transmitted as target braking force for the rear wheels.

The invention also has as its object a braking system intended to be fitted to a vehicle including a plurality of sensors, a braking controller, brake caliper activation units and at least electromechanical brake calipers fitted to the rear wheels of the vehicle, wherein the braking controller is a braking controller such as described above.

Lastly, the invention has as its object a vehicle including a braking system as described above.

### BRIEF DESCRIPTION OF THE DRAWINGS

The invention will be better understood and other aims, details, characteristics and advantages of it will become more clearly apparent in the course of the following description of a particular embodiment of the invention, given solely in illustrative and non-limiting manner, with reference to the attached drawings. In these drawings:

FIG. 1 shows diagrammatically a vehicle fitted with a hybrid braking system;

FIGS. 2A, 2B, and 2C show, in the form of flow-charts, the different steps of an embodiment of the process in accordance with the invention;

FIG. 3 shows a curve giving the base gain as a function of the velocity of the vehicle;

FIG. 4 shows the braking forces respectively applied to the front and rear wheels during a test in which braking management in accordance with the process of the invention is active; and

FIG. 5 shows the respective velocities of the front and rear wheels over time, during the test producing FIG. 4.

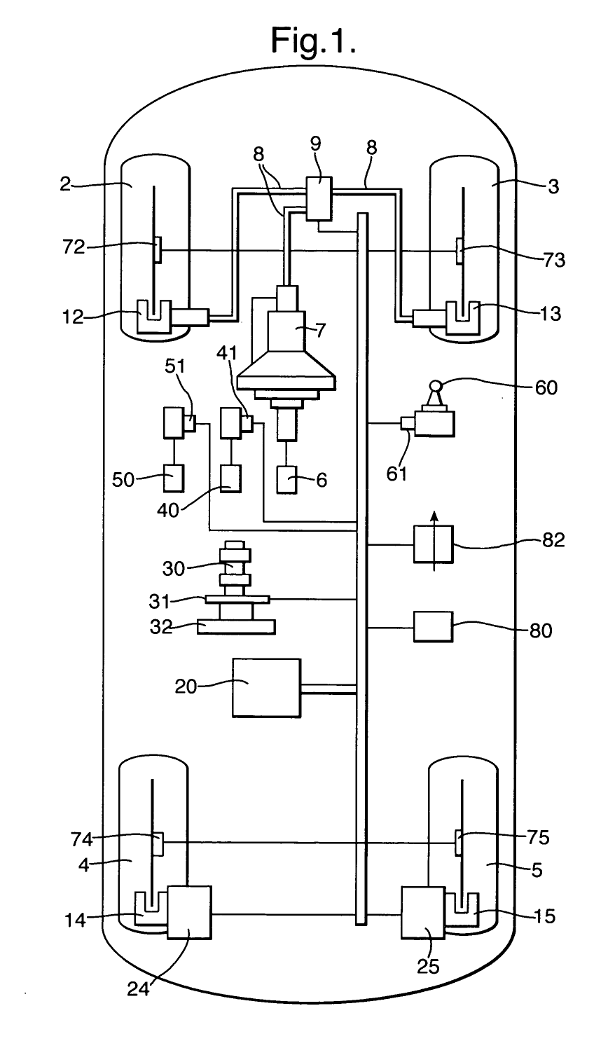

### DESCRIPTION OF THE PREFERRED EMBODIMENT

To limit the pitching motion of the vehicle body, the process in accordance with the invention consists of applying a braking force to the rear wheels greater than the braking force required by the driver pressing on the brake pedal to decelerate. This additional braking force leads to the application to the body of an additional moment permitting lifting of the nose of the vehicle and zeroing or at least reducing the angle of pitch.

Since the braking force effectively applied to the rear wheels does not correspond to the braking force required by the driver, the process in accordance with the invention can only be implemented in a vehicle including a braking system decoupled from the operation of the brake pedal, at least for on of the brake calipers fitted to the rear wheels. The vehicle in which activation is implemented is preferably a vehicle including a hybrid braking system, but can also be a vehicle including an entirely electronically managed braking system.

A vehicle 1 includes two front wheels 2 and 3 and two rear wheels 4 and 5. The hybrid braking system includes a brake pedal 6 connected to a master-cylinder 7. When the brake pedal 5 is depressed by the driver wishing the vehicle to be braked, the master-cylinder 7 generates an hydraulic over-pressure which is propagated via the hydraulic unit 9 and the piping 8 to the hydraulic brake calipers 12 and 13 fitted to the front wheels 2 and 3 respectively.

The rear wheels 4 and 5 are respectively fitted with electromechanical calipers 14 and 15. When the driver presses on the brake pedal 6, the hydraulic unit 9 also emits an electrical signal corresponding to the over-pressure generated by the master-cylinder 7, indicating the value of the braking force Fc required by the driver. It is to be noted that the required value of the braking force Fc is that which is effectively applied to the two front wheels.

The electrical signal S is applied to an input of a braking controller 20. The braking controller 20 includes at least a computer and a memory. The memory is able to store the instructions of different programs. The computer is able to execute these instructions. The controller 20 includes an input/output interface permitting at its input acquisition of signals from different sensors and storage of the corresponding values in pre-defined memory spaces, and permitting at its output emission of signals as a function of values read from pre-defined memory spaces.

In response to the signal S, the controller 20 determines whether the brake pedal is depressed (for example S different from the value zero). Then, if such is the case, the controller 20 periodically calculates the target braking forces having to be applied by the calipers 14 and 15 respectively. The controller 20 transmits at its output control signals corresponding to the target braking forces to remote activators 24 and 25 controlling the activation of the rear calipers.

More precisely and in known manner, calculation by the controller 20 of a target braking force consists of determining a base braking force and then applying different functions in order to modulate the base braking value. For example, a wheel anti-skid function corrects the base braking force as a function of the value of the instantaneous slip of the wheels. For example again, a stability control function can increase the base braking force at one of the wheels to increase the stability of the vehicle engaged in a bend. Each of these functions, triggered as a function of particular entry conditions, leads to the calculation of a reference braking force and of a flag indicating the priority level of the reference braking force thus calculated. Finally, an arbitration device allocates the value of the reference braking force having the highest priority to the target braking force to be transmitted to the corresponding caliper.

Moreover, the vehicle 1 is provided with a plurality of sensors permitting measurement of the instantaneous value of different variables, so as to define an instantaneous state of the vehicle. The steering column 30 is, for example, provided with a sensor 31 permitting measurement of the angle of lock which the driver is applying to the steering-wheel 32. The accelerator pedal 40 includes a sensor 41 permitting measurement of the degree of depression of the accelerator pedal. The clutch pedal 50 includes a sensor 51 permitting determination of the state of engagement: declutched state in which the engine is connected to the drive wheels, clutched state in which the engine is disconnected from the drive wheels and intermediate slip state in which the drive torque is only partially applied to the drive wheels. Lastly, the vehicle 1, if it has a manual gearbox 60, can be provided with a sensor 61 permitting knowledge of the position of the gear lever. The vehicle 1 also includes sensors permitting determination of the kinematic state of the vehicle. Each of the wheels 2-5 is provided with a wheel velocity sensor 72-75 permitting measurement of the instantaneous rotational velocity of the wheel. This information allows the controller 20 to calculate an instantaneous velocity V of the vehicle. In order to measure acceleration, the vehicle includes for example a lateral acceleration sensor 80 and a longitudinal acceleration sensor 82. The different sensors described are connected to the controller 20 via a network, for example supporting the CAN-Bus protocol.

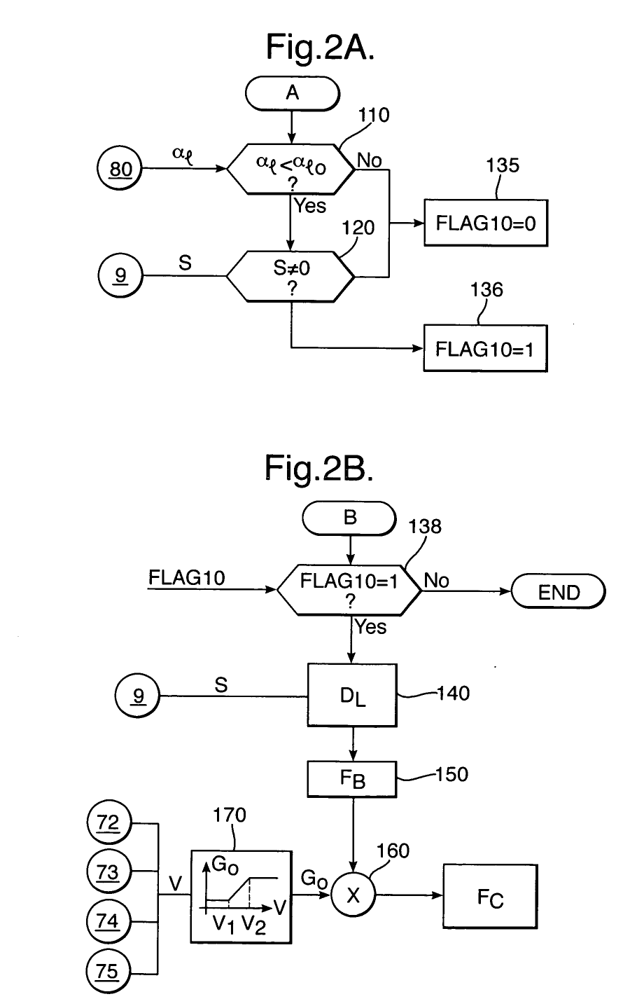

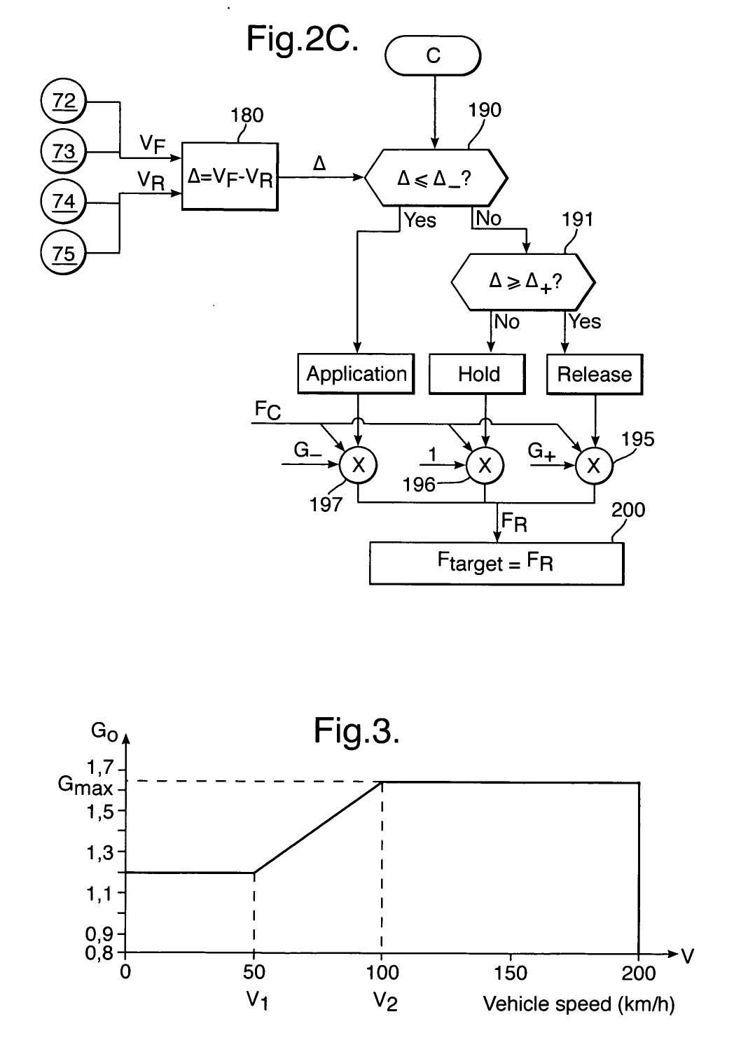

With reference now to FIGS. 2A, 2B and 2C, the different steps of the process in accordance with the invention will be described. Preferably, the process is implemented by software. The software instructions are stored in a memory of the controller 20 and are executed by the processor of the controller 20.

In FIG. 2A, the process includes the execution of a module A permitting determination of a logical entry condition permitting knowledge of whether the instantaneous state of the vehicle corresponds to a state in which over-braking can be applied. The reduction of the angle of pitch is only effected when the vehicle is in a straight line and when the brake pedal is operated. The logical entry condition therefore includes a straight line test 110 consisting of determining whether the instantaneous value of the lateral acceleration a₁, measured by the sensor 80, is less than a threshold lateral acceleration a₁₀ having a low value for example of 0.02 g. The logical entry condition also includes a braking test 120 consisting of determining whether the signal S emitted by the sensor 9 has a non-zero value indicating depression of the brake pedal 6. When one of the straight line and braking tests is not verified, the value zero is assigned (step 135) to a binary flag FLAG10 thus signifying that the instantaneous state of the vehicle is incompatible with over-braking. When the straight line test and a braking test are simultaneously verified, the logical entry condition is itself verified, and the binary flag FLAG10 passes from the value zero to the value unity (step 136) indicating that the state of the vehicle is compatible with the application of an additional rear braking force, determination of which will now be described in detail. The straight line and braking tests are performed periodically. The instantaneous value of the flag FLAG10 is stored in the memory of the controller 20.

FIG. 2B shows a module B permitting calculation of a corrected base braking force. In step 138, the current value of the flag FLAG10 is compared with unity. When the logical entry condition is verified, i.e. FLAG10=1, the process passes to step 140 of evaluation of the required longitudinal deceleration D_{L}. The deceleration D_{L} is determined from the amplitude of the signal S transmitted by the sensor 9. From the deceleration D_{L}, a base braking force F_{B} is calculated in step 150. The base braking force F_{B} corresponds to the force which would have to be applied simultaneously to the front wheels and to the rear wheels for the instantaneous deceleration of the vehicle to correspond to the deceleration DL required by the driver operating the brake pedal 6. The calculation, which is moreover known, of the base braking force F_{B} involves particular characteristics of the vehicle in question, such as the body mass, the stiffness of the suspensions, etc.

The invention being implemented in a hybrid braking system, the base braking force F_{B} is used for calculation of the target braking force F_{target} to be applied to the rear wheels. If the invention were implemented in a completely electronically managed braking system, the base braking force F_{B} would also permit calculation of the target braking force to be applied to the front wheels.

To reduce the angle of pitch, a base gain G₀ is applied to the base braking force F_{B} so as to obtain a corrected base braking force F_{C} (step 160). For this purpose, the instantaneous longitudinal velocity V, calculated from the angular rotational velocities of each of the wheels measured by the sensors 72 to 75, is determined. In step 170, a calibration curve permits knowledge of the base gain G₀ to be applied as a function of the longitudinal velocity V. Such a calibration curve is shown in FIG. 3. The calibration curve is an increasing function of the velocity V. In the preferred embodiment, the calibration curve is a piecewise continuous function: when the velocity V is lower than a lower threshold velocity V₁, the correction to be applied to the base braking force is both small and constant. The base gain G₀ is close to unity and is for example 1.2 for this velocity range. In fact, at low velocities, the angle of pitch is small. It only inconveniences the driver to a very small extent. Moreover, too great activation of the rear brakes would be perceived by the driver and would constitute a source of discomfort. Conversely, when the velocity V is greater than an upper threshold velocity V₂, the base gain G₀ is a constant saturation gain Gₘₐₓ. By way of example, in FIG. 3, Gₘₐₓ is 1.6. Lastly, when the velocity V is between the lower threshold velocity V₁ and the upper threshold velocity V₂, the base gain G₀ is an increasing linear function of the velocity. Other values can be allocated to the parameters of the calibration curve so as to give a particular character to the vehicle. As a modification, other forms of calibration curve can be used. The corrected base braking force Fc is greater than the base force F_{B}, the base gain being greater than unity whatever the value of the velocity V.

Since it is required that the additional braking force should be constant when the required deceleration D_{L} is constant, the base gain G₀ is only determined at each modification of the value of the deceleration D_{L}. This comes down to taking into account the longitudinal velocity V only on a change of deceleration D_{L}.

The corrected base force F_{C} thus calculated could be applied directly as target braking force F_{target}. However, on deceleration and due to the angle of pitch, the transfer of load from the rear to the front results in the reduction of the normal reaction forces of the road on the rear wheels. Thus, if too much braking is applied to the rear wheels, there is a risk of saturation leading to locking and then to slip of the rear wheels. Now, if the rear wheels lock, the vehicle is in an unstable situation. For a vehicle fitted with it, the wheel anti-lock function (ABS) is triggered, which is detrimental to passenger comfort. Slip of the rear wheels must therefore be monitored on application of an additional braking force. A braking force must be applied which is the highest possible for maximum reduction of the angle of pitch, while not being too great so that the slip of the rear wheels is kept at a reasonable value. For example, in what follows, the difference in velocity between the front wheels and rear wheels, a magnitude equivalent to the slip, is some kilometres per hour (km/h).

With reference to FIG. 2C, the corrected base braking force F_{C} is therefore modulated so as not to cause too great a slip. In step 180, the slip Δ is calculated by the difference between the instantaneous front V_{F} and rear V_{R} velocities respectively obtained by means of the front wheel velocities (obtained by means of sensors 72 and 73) and rear wheel velocities (obtained by means of sensors 74 and 75).

In step 190, the instantaneous slip Δ is compared with a lower threshold slip Δ₋ of for example −0.5 km/h. If the instantaneous slip Δ is less than Δ₋, the system enters an application mode described below. In the contrary case, the instantaneous slip Δ is compared with an upper threshold slip Δ₊ of for example 2 km/h. If the instantaneous slip Δ is greater than Δ₊, the system enters a release mode described below. Lastly, in the contrary case, the instantaneous slip Δ being between Δ₋ and Δ₊, the system enters a maintaining mode described below.

If the system is in the Release mode, this means that the slip is too great and that the amplitude of the corrected base braking force F_{C} must be reduced. To do this, in step 195, the corrected braking force F_{C} is multiplied by a reduction gain G₊ which is less than unity. The reference braking force F_{R} thus determined is less than the corrected base braking force F_{C}.

Conversely, in the Activation mode, i.e. when the slip Δ is very small, the amplitude of the corrected braking force F_{C} can be increased to correct the trim of the body as much as possible. Thus, in step 197, the corrected braking force F_{C} is multiplied by an increase gain G₋ which is greater than unity. The reference braking force F_{R} thus determined is greater than the corrected base braking force F_{C}.

Lastly, in Maintaining mode, the slip being at a suitable level, the corrected base force F_{C} is not to be modified. In FIG. 2C, in step 196, the corrected base force F_{C} is multiplied by unity to obtain the reference braking force F_{R}.

It is to be noted that this function for controlling braking as a function of slip is moreover known. A simple version of this function has been presented above in which constant multiplying gains have been applied to the corrected base braking force F_{C}. Other ways of modulating the corrected base braking force F_{C} are possible. Conversely, the values of the lower and upper slip thresholds of this function for control of base braking are suited to the particular case of increasing the base braking force to reduce the angle of pitch.

In step 200, the reference braking force F_{R} is transmitted as target braking force F_{target} to each of the activators 25 and 26 of the electromechanical brake calipers fitted to the rear wheels. At this stage, the target braking forces for the right and left rear wheels are identical. Optionally, the activators 24 and 25 can modify the value of the target braking force sent to them as a function of particular conditions at each of the wheels.

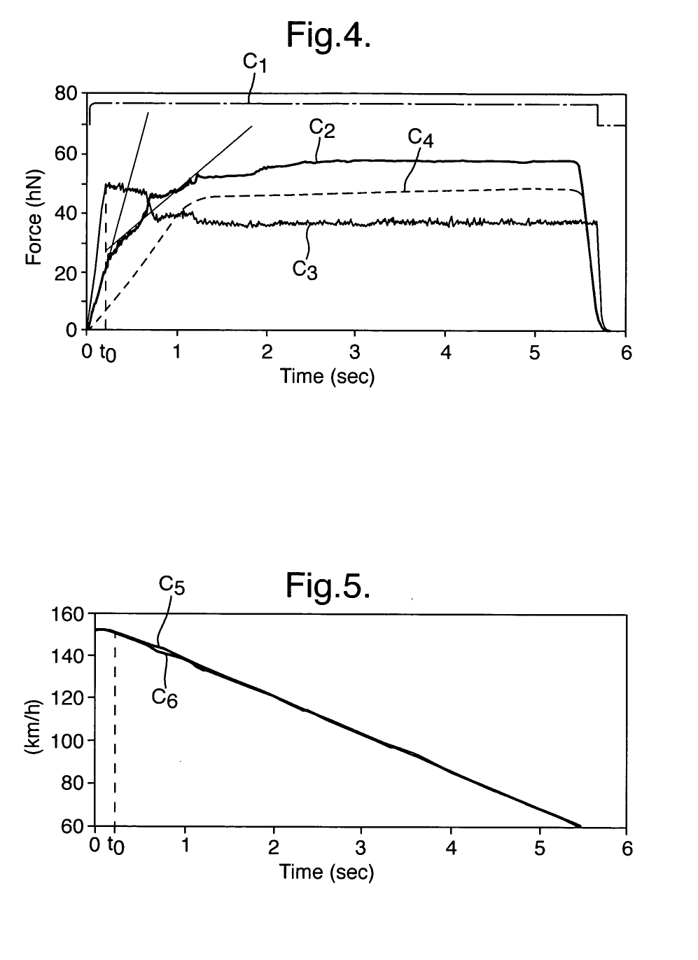

FIGS. 4 and 5 show curves representing the temporal evolution of kinematic magnitudes measured in the course of a test performed on a vehicle implementing the process in accordance with the invention. In FIG. 4, the curve C₁ shows the value of the flag FLAG10. At the start of the test, the value of FLAG10 is zero, which means that the software is not being executed. After some tenths of a second, the value of the flag FLAG10 passes to the value unity, which means that management of rear over-braking has been entered. The curve C₂ represents the force applied at one of the rear wheels; the curve C₃ represents the force at the other rear wheel. The variations in clamping forces between these two curves represent the modulation of the forces to optimise braking on the rear train. It is found that the braking force increases rapidly at the start of the test to then remain at around 4000 Newtons. After 5.5 seconds, the driver totally releases the brake pedal. This causes the flag FLAG10 to readopt a zero value and the braking force to be brought to zero. The curve C₄, shown in dotted lines, gives the braking force which would be applied to the rear wheels of an equivalent vehicle not implementing the process in accordance with the invention. The curves C₂ and C₃ are above the curve C₄ from the start of the test. This means that a base gain greater than unity is applied to the base clamping force so as increase braking on the rear wheels relative to what it would normally be.

FIG. 5 shows the velocity of the front wheels, curve C₅, and the velocity of the rear wheels, curve C₆. The difference between these two curves indicates the variable Δ corresponding to the slip. For example, at the instant to, the difference between the velocity of the front wheels and the velocity of the rear wheels is large and exceeds the 2 km/h value of the upper slip threshold Δ₊. Consequently, the reduction gain G₊ is applied so that the corrected base braking force F_{C} is reduced. This is indeed what is found in FIG. 4 in which, at the instant t₀, the curves C₂ and C₃ undergo a large change of gradient indicating a change in modulation gain.

Although the invention has been described in relation to a particular embodiment, it is quite obvious that it is in no way limited to this and that it includes all the technical equivalents of the means described and their combinations if these fall within the framework of the invention.

1. A process for braking a vehicle, the vehicle being fitted with a braking system including brake calipers which can be activated as a function of a target braking force and in which at least the activation of the calipers fitted to the rear wheels is decoupled from depression of a brake pedal, which depression corresponds to a braking force required by the driver, said process including:
detecting a logical entry condition including at least a straight line test and a braking test, the straight line test being verified when the instantaneous lateral acceleration of the vehicle is less than a threshold acceleration and the braking test being verified when the brake pedal is operated by the driver; and while the logical condition is detected,
determining a base braking force from the required braking force;
calculating a corrected base braking force, by correcting the base braking force so that the corrected base braking force is greater than the base braking force; and
applying the corrected base braking force as target braking force for the rear wheels, so that the pitching motion of the vehicle is reduced on braking in a straight line.

2. The process of claim 1, wherein the base braking force is corrected by applying to it a multiplying base gain so as to obtain a corrected base braking force.

3. The process of claim 2, wherein the base gain is an increasing function of an instantaneous velocity of the vehicle.

4. The process of claim 3, wherein the instantaneous velocity on which the base gain depends is the instantaneous velocity on a modification of the braking force required by the driver.

5. The process of claim 2, wherein the base gain is within about 0.2 of unity below a lower threshold velocity.

6. The process of claim 2, wherein the base gain is equal to a saturation gain above an upper threshold velocity.

7. The process of claim 1, further comprising modulating the corrected base braking force to obtain a reference braking force, the modulation being a function of the instantaneous value of a variable reflecting the slip of the rear wheels, and the reference braking force being transmitted as target braking force for the rear wheels.

8. Braking software containing instructions suitable to be read from and stored on a support, said instructions being executable by a host computer, wherein said software implements the process of claim 1.

9. A programmable braking controller, able to implement the process of claim 1, in a vehicle fitted with a braking system including brake calipers able to be activated as a function of a target braking force and in which at least the activation of the brake calipers fitted to the rear wheels is decoupled from depression of a brake pedal, which depression corresponds to a braking force required by the driver, said controller including a memory space able to store software instructions, a computer able to execute said instructions and an input/output interface connectable at its input to a plurality of sensors with which the vehicle is provided and at its output to at least one unit for caliper activation, said controller being programmed to include:
a means for detecting a logical entry condition able to test a straight line condition by verifying whether a lateral acceleration obtained by means of the sensors is less than a threshold lateral acceleration, and a braking condition by verifying whether the brake pedal is depressed;
a means for determining a base braking force from the required braking force;
a means for calculating a corrected base braking force able to correct the base braking force so that the corrected base braking force is greater than the base braking force; and
a means for transmitting the corrected braking force as target braking force for the rear wheels, so that the pitching motion of the vehicle is reduced on deceleration.

10. The programmable braking controller of claim 9 further comprising modulation means able to apply a modulation to the corrected base braking force to obtain a reference braking force, the modulation being a function of a variable reflecting the slip of the rear wheels, and the reference braking force being transmitted as target braking force for the rear wheels.

11. A braking system intended to be fitted to a vehicle including a plurality of sensors, a braking controller, units for activation of brake calipers, and at least electromechanical brake calipers fitted to rear wheels of the vehicle, wherein said braking controller is the programmable braking controller of claim 9.

12. A vehicle including the braking system of claim 11.
